(19) United States
(12) Patent Application Publication
(10) Pub. No.: US 2014/0086419 A1
(43) Pub. Date: Mar. 27, 2014

(54) Method for capturing and using audio or sound signatures to analyse vehicle accidents and driver behaviours

(71) Applicants: Manjit Rana, Nottingham (GB); Christopher Nicholas Denison, Olney (GB)

(72) Inventors: Manjit Rana, Nottingham (GB); Christopher Nicholas Denison, Olney (GB)

(21) Appl. No.: 13/629,526

(22) Filed: Sep. 27, 2012

(51) Int. Cl. G06Q 40/08; H04R 29/00

(52) U.S. Cl. CPC G06Q 40/08; H04R 29/00
USPC 381/56

(57) ABSTRACT

The use of sound pattern matching methods and techniques to analyse driver behavior and accidents and provide alerts to drivers, passengers, insurers or accident management companies. While a driver is operating a vehicle on the road, sound signatures are captured from a smartphone, in car microphone, retrofitted telematics unit or other device with audio capture capabilities. The sound signatures captured are recorded, analysed and matched against known and/or previously recorded sound patterns to help determine circumstances relating to a vehicle accident event or incident. Examples of recorded and matched sound signatures include the “rumbling” sound when driving over cats eyes or edging strips on roads, the skidding sound when braking harshly or an airbag explosion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Over a million people die in motor accidents around the world each year, by 2020 road traffic accidents could outstrip stroke and HIV as one of the main causes of preventable deaths.

Motor insurance premiums are inflated due to fraudulent claims and the costs incurred through insurance companies not being able to take immediate control and manage the expenses incurred in settling a claim.

The technology in vehicles, telematics units and smartphones is becoming increasingly sophisticated making it possible to capture ambient (background) noise and analyse the data for sound based clues or indications of the driver falling asleep or driving under the influence of drink or drugs.

Capturing the sound profile before and during an accident may also help the insurance company and accident investigators to establish fault, cause and circumstances of the accident.

### BRIEF SUMMARY OF THE INVENTION

The use of sound pattern matching methods and techniques to analyse driver behavior and accidents and provide alerts to drivers, passengers, insurers or accident management companies.

While a driver is operating a vehicle on the road, sound signatures are captured from a smartphone, in car microphone, retrofitted telematics unit or other device with audio capture capabilities. The sound signatures captured are recorded, analysed and matched against known and/or previously recorded sound patterns to help determine circumstances relating to a vehicle accident event or incident. Examples of recorded and matched sound signatures include the “rumbling” sound when driving over cats eyes or edging strips on roads, the tyre skidding sound when braking harshly or an airbag explosion.

### BRIEF DESCRIPTION OF THE SEVERAL VIEWS OF THE DRAWING

FIG. 1—Diagram to illustrate the general process

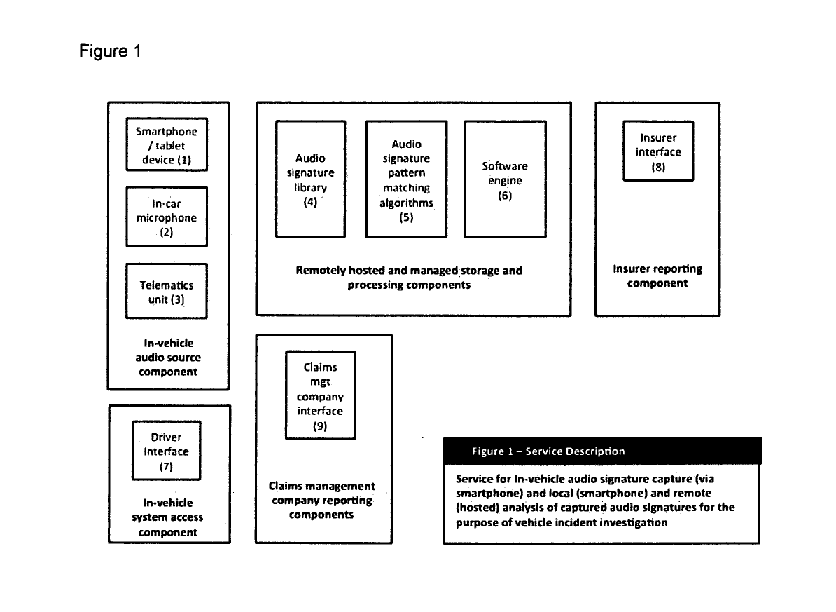

### DETAILED DESCRIPTION

The following description of at least one exemplary embodiment is merely illustrative in nature and is in no way intended to limit the invention, its application, or uses.

Through the automatic capture and analysis of ambient noise whilst travelling in a motor vehicle it is possible to identify events that may be caused through the driver not being fully in control of the vehicle.

Having identified such events it will be possible to alert the driver to take corrective action.

In the case of the vehicle being involved in an accident the captured sound data can be analysed to provide an improved claims management service to the vehicle driver and a more cost effective claim settlement opportunity for the insurance company.

Smartphones or Tablet computer (1), in-car microphones (2), retro-fitted telematics devices (3) or other in-car or portable devices with audio recording capability would capture ambient noise during a vehicle journey and temporarily stored in the devices memory or memory connected to the device using a direct, Bluetooth, wifi, mobile network, NFC or some other connection method.

The sound data will be checked against a library (4) of known sound patterns stored on the smartphone, device connected memory and/or in a remote cloud storage facility to determine matches similar in the way that Shazam and SoundHound uses sound matching protocols to identify music tracks.

The Sound Signature Library (4) may include many sound samples each with a unique identifier.

The sound data will be analysed to look for patterns or signatures using in-house developed or licensed algorithms (5), that may indicate certain events having taken place such as the vehicles tyres skidding.

If the pattern matching or sound signature identifies a certain event the software engine (6) will provide an alert to the relevant party or parties (7, 8, and 9) either through a visual, audio, SMS Text, email, web-services message.

The captured sound data may be used to enhance the sound pattern or signature library to improve the service or accuracy.

1. A method comprising:
receiving a stream of sound related data;
Analysing and comparing elements of the data against a library of sound profiles or signatures;
The data may be collected from several sources, including but not limited to;
1.1 An in-car microphone
1.2 A telematics unit fitted to the car
1.3 A smartphone with software designed to capture ambient (background) noise

2. A library of previously collated sound signatures or profiles related but not limited to;
2.1 Driver behavior including but not limited to, rumbling noise pattern when driving over cats eyes or when driving over textured edging strips on roads
2.2 a vehicle's tyres skidding on the road surface due to hard braking
2.3 the noise of an airbag inflating during an accident
2.4 the noise from the vehicle due to an impact

3. The storing and indexing of the collated data and related information

4. The matching techniques used to identify potential matches between captured data as in claim 1 and the known sound profiles as in claim 2

5. The software that provides feedback to the driver or passengers in the vehicle which may be through an audio, visual, text SMS, email, instant message, web-services connection or any other means

6. The software that provides feedback to the insurance company providing cover for the driver or passengers in the vehicle concerned. which may be through an audio, visual, text SMS, email, instant message, web-services connection or any other means

7. The software that provides feedback to any third party organization with an interest in the driver behavior during a journey or immediately before, during or and after an accident or incident, which may be through an audio, visual, text SMS, email, instant message, web-services connection or any other method
